(19) United States
(12) Patent Application Publication
(10) Pub. No.: US 2025/0196875 A1
(43) Pub. Date: Jun. 19, 2025

(54) VEHICLE TRAJECTORY WARNING METHOD AND APPARATUS, VEHICLE AND STORAGE MEDIUM

(71) Applicant: Faurecia Clarion Electronics (Xiamen) Co., Ltd., Xiamen (CN)

(72) Inventors: Shude CHEN, Xiamen (CN); Qiuyun YE, Xiamen (CN); Hongping HUANG, Xiamen (CN)

(73) Assignee: Faurecia Clarion Electronics (Xiamen) Co., Ltd., Xiamen (CN)

(21) Appl. No.: 18/969,580

(22) Filed: Dec. 5, 2024

(30) Foreign Application Priority Data
Dec. 14, 2023 (CN) 202311728798.7

(51) Int. Cl. B60W 50/14; B60W 30/095

(52) U.S. Cl. CPC B60W 50/14; B60W 30/095; B60W 2050/146; B60W 2554/4041; B60W 2554/4042; B60W 2554/4044

(57) ABSTRACT

A vehicle trajectory warning method and apparatus, a vehicle and a storage medium are provided. The method includes: acquiring obstacle information within a preset range of a vehicle and driving trajectory information of the vehicle, the obstacle information includes a position, a moving speed and a moving direction of each obstacle, and the driving trajectory information is used to indicate a driving trajectory area of the vehicle; determining a period of collision time of the each obstacle to the driving trajectory area according to the position, the moving speed and the moving direction of the each obstacle and the driving trajectory information, and determining an obstacle corresponding to a shortest period of collision time in multiple periods of collision time shorter than a first preset threshold as a target obstacle; displaying warning information indicating the target obstacle in a driving trajectory displayed by the vehicle.

### CROSS-REFERENCE TO RELATED APPLICATION(S)

The present disclosure is filed based on Chinese Patent Application with the application No. 202311728798.7, filed on Dec. 14, 2023, and claims priority to the Chinese Patent Application, the entire content of the Chinese Patent Application is incorporated herein by reference.

### TECHNICAL FIELD

The present disclosure relates to the field of vehicle technology, and in particular, to a vehicle trajectory warning method and apparatus, a vehicle and a storage medium.

### BACKGROUND

A Camera Monitor System (Camera Monitor System, CMS) is a monitoring system composed of a camera and a sensor, and can acquire and display driving trajectories and surrounding obstacles of a vehicle, thereby improving the safety of the vehicle during driving.

### SUMMARY

In a first aspect, there is provided a vehicle trajectory warning method, including: acquiring obstacle information within a preset range of a vehicle and driving trajectory information of the vehicle, where the obstacle information includes a position, a moving speed and a moving direction of each obstacle, and the driving trajectory information is used to indicate a driving trajectory area of the vehicle; determining a period of collision time of the each obstacle to the driving trajectory area according to the position, the moving speed and the moving direction of the each obstacle and the driving trajectory information; determining an obstacle corresponding to a shortest period of collision time in multiple periods of collision time shorter than a first preset threshold as a target obstacle, where the first preset threshold is determined according to a collision risk degree of an obstacle; and displaying warning information indicating the target obstacle in a driving trajectory displayed by the vehicle.

In some embodiments, the warning information includes: a direction mark for indicating an obstacle direction; before displaying the warning information indicating the target obstacle in the driving trajectory displayed by the vehicle, the method further includes: determining a target direction and a target position according to a position of the target obstacle and the driving trajectory information, where the target direction is a direction of the target obstacle with respect to the driving trajectory, the target position is a position in the driving trajectory and that is closest to the position of the target obstacle; the displaying the warning information indicating the target obstacle in the driving trajectory displayed by the vehicle includes: displaying a direction mark of the target direction at the target position in the driving trajectory displayed by the vehicle.

In some embodiments, the obstacle information further includes a type of the each obstacle, direction marks of different types of obstacles are different, and the displaying the direction mark of the target direction at the target position in the driving trajectory displayed by the vehicle includes: displaying a direction mark of the target direction corresponding to a type of the target obstacle at the target position in the driving trajectory displayed by the vehicle.

In some embodiments, the obstacle information further includes a size of the each obstacle, the warning information further includes: a first warning color for indicating a first collision risk degree, a second warning color for indicating a second collision risk degree, and a third warning color for indicating a third collision risk degree, risk degrees of the first collision risk degree, the second collision risk degree, and the third collision risk degree decrease in sequence, and color reminder levels of the first warning color, the second warning color, and the third warning color decrease in sequence; in a case where a period of collision time of the target obstacle to the driving trajectory area is shorter than or equal to a second preset threshold, before displaying the warning information indicating the target obstacle in the driving trajectory displayed by the vehicle, the method further includes: determining a displaying area and a displaying size of the first warning color in the driving trajectory according to a size of the target obstacle and the target position, where the displaying area is an area spreading from the target position to both sides of the driving trajectory, the displaying size is a physical size of the target obstacle mapped on the driving trajectory, and the second preset threshold is shorter than the first preset threshold; the displaying the warning information indicating the target obstacle in the driving trajectory displayed by the vehicle includes: displaying the first warning color in the driving trajectory displayed by the vehicle based on the displaying area and the displaying size of the first warning color in the driving trajectory, and displaying, in an area other than the displaying area of the first warning color and in the driving trajectory, the second warning color and the third warning color sequentially in transition.

In some embodiments, in a case where the period of collision time of the target obstacle to the driving trajectory area is longer than the second preset threshold and shorter than the first preset threshold, before displaying the warning information indicating the target obstacle in the driving trajectory displayed by the vehicle, the method further includes: determining a displaying area and a displaying size of the second warning color in the driving trajectory according to the size of the target obstacle and the target position; the displaying the warning information indicating the target obstacle in the driving trajectory displayed by the vehicle includes: displaying the second warning color in the driving trajectory displayed by the vehicle based on the displaying area and the displaying size of the second warning color in the driving trajectory, and displaying, in an area other than the displaying area of the second warning color and in the driving trajectory, the third warning color in transition.

In a second aspect, there is provided a vehicle trajectory warning apparatus including: an acquisition unit, a determination unit and a displaying unit. The acquisition unit is configured to acquire obstacle information within a preset range of a vehicle and driving trajectory information of the vehicle, where the obstacle information includes a position, a moving speed and a moving direction of each obstacle, and the driving trajectory information is used to indicate a driving trajectory area of the vehicle; the determination unit is configured to determine a period of collision time of the each obstacle to the driving trajectory area according to the position, the moving speed and the moving direction of the each obstacle and the driving trajectory information; the determination unit is further configured to determine an obstacle corresponding to a shortest period of collision time in multiple periods of collision time shorter than a first preset threshold as a target obstacle, where the first preset threshold is determined according to a collision risk degree of an obstacle; and the displaying unit is configured to display warning information indicating the target obstacle in a driving trajectory displayed by the vehicle.

In some embodiments, the warning information includes: a direction mark for indicating an obstacle direction; the determination unit is further configured to determine a target direction and a target position according to a position of the target obstacle and the driving trajectory information, where the target direction is a direction of the target obstacle with respect to the driving trajectory, the target position is a position in the driving trajectory and that is closest to the position of the target obstacle; the displaying unit is specifically configured to: display a direction mark of the target direction at the target position in the driving trajectory displayed by the vehicle.

In some embodiments, the obstacle information further includes a type of the each obstacle, direction marks of different types of obstacles are different, and the displaying unit is specifically configured to: display a direction mark of the target direction corresponding to a type of the target obstacle at the target position in the driving trajectory displayed by the vehicle.

In some embodiments, the obstacle information further includes a size of the each obstacle, the warning information further includes: a first warning color for indicating a first collision risk degree, a second warning color for indicating a second collision risk degree, and a third warning color for indicating a third collision risk degree, risk degrees of the first collision risk degree, the second collision risk degree, and the third collision risk degree decrease in sequence, and color reminder levels of the first warning color, the second warning color, and the third warning color decrease in sequence; in a case where a period of collision time of the target obstacle to the driving trajectory area is shorter than or equal to a second preset threshold, the determination unit is further configured to determine a displaying area and a displaying size of the first warning color in the driving trajectory according to a size of the target obstacle and the target position, where the displaying area is an area spreading from the target position to both sides of the driving trajectory, the displaying size is a physical size of the target obstacle mapped on the driving trajectory, and the second preset threshold is shorter than the first preset threshold; the displaying unit is specifically configured to: display the first warning color in the driving trajectory displayed by the vehicle based on the displaying area and the displaying size of the first warning color in the driving trajectory, and display, in an area other than the displaying area of the first warning color and in the driving trajectory, the second warning color and the third warning color sequentially in transition.

In some embodiments, in a case where the period of collision time of the target obstacle to the driving trajectory area is longer than the second preset threshold and shorter than the first preset threshold, the determination unit is further configured to determine a displaying area and a displaying size of the second warning color in the driving trajectory according to the size of the target obstacle and the target position; the displaying unit is specifically configured to: display the second warning color in the driving trajectory displayed by the vehicle based on the displaying area and the displaying size of the second warning color in the driving trajectory, and display, in an area other than the displaying area of the second warning color and in the driving trajectory, the third warning color in transition.

In a third aspect, there is provided a vehicle trajectory warning apparatus, including a memory and a processor; the memory is configured to store computer execution instructions, and the processor is connected to the memory through a bus; when the vehicle trajectory warning apparatus is running, the processor executes the computer execution instructions stored in the memory, to enable the vehicle trajectory warning apparatus to perform the vehicle trajectory warning method as described in the first aspect.

In a fourth aspect, there is provided a computer-readable storage medium, where the computer-readable storage medium includes computer execution instructions that, upon being run on a computer, enable the computer to perform the vehicle trajectory warning method as described in the first aspect.

In a fifth aspect, there is further provided a computer program product, where the computer program product includes computer instructions, when the computer instructions are executed on a vehicle trajectory warning apparatus, the vehicle trajectory warning apparatus is enabled to perform the vehicle trajectory warning method as described in the first aspect.

It should be noted that all or part of the above-mentioned computer instructions may be stored on a first computer-readable storage medium. Herein, the first computer-readable storage medium may be packaged together with the processor of the vehicle trajectory warning apparatus, or may be packaged separately with the processor of the vehicle trajectory warning apparatus, which is not limited in the present disclosure.

In a sixth aspect, there is provided a vehicle, including the vehicle trajectory warning apparatus as described in the third aspect.

### BRIEF DESCRIPTION OF THE DRAWINGS

FIG. 1 is a structural schematic diagram of a vehicle trajectory warning system provided in the embodiments of the present disclosure.

FIG. 2 is a structural schematic diagram of hardware of a vehicle trajectory warning apparatus provided in the embodiments of the present disclosure.

FIG. 3 is a schematic flowchart of a vehicle trajectory warning method provided in the embodiments of the present disclosure.

FIG. 4 is a schematic diagram of a displaying interface of warning information provided in the embodiments of the present disclosure.

FIG. 5 is a schematic flowchart of another vehicle trajectory warning method provided in the embodiments of the present disclosure.

FIG. 6 is a schematic flowchart of yet another vehicle trajectory warning method provided in the embodiments of the present disclosure.

FIG. 7 is a schematic flowchart of yet another vehicle trajectory warning method provided in the embodiments of the present disclosure.

FIG. 8 is a schematic flowchart of yet another vehicle trajectory warning method provided in the embodiments of the present disclosure.

FIG. 9 is a structural schematic diagram of a vehicle trajectory warning apparatus provided in the embodiments of the present disclosure.

### DETAILED DESCRIPTION

The technical solutions in embodiments of the present disclosure will be described below clearly and completely with reference to the accompanying drawings in embodiments of the present disclosure. Obviously, the described embodiments are merely a part of the embodiments of the present disclosure, but not all of the embodiments of the present disclosure. All other embodiments obtained based on the embodiments of the present disclosure by a person of ordinary skill in the art without paying any creative effort shall be included in the protection scope of the present disclosure.

It should be noted that in the embodiments of the present disclosure, wordings, such as “exemplarily” or “for example” and variations thereof are used to indicate examples, demonstrations, or illustrations. Any embodiment or design solution described with “exemplary” or “for example” and variations thereof in the present disclosure should not be illustrated as a more preferred or advantageous embodiment or design solution over other embodiments or design solutions in the present disclosure. Specifically, the usage of the wordings such as “exemplarily” or “for example” and variations thereof are intended to present relevant concepts in a concrete way.

In order to facilitate a clear description of the technical solutions of the embodiments of the present disclosure, in the embodiments of the present disclosure, wordings such as “first” and “second” are used to distinguish same items or similar items with the substantially same functions and effects. Those skilled in the art can understand that the wordings such as “first” and “second” do not limit a quantity and an order of execution.

Furthermore, the terms “including” and “having” and any variations thereof mentioned in the present disclosure are intended to cover non-exclusive inclusions.

Upon displaying the obstacles around the vehicle, the CMS usually frames an obstacle and displays the framed result. The displaying interface is relatively complex, thereby resulting in a poor user experience. Next, since the CMS is usually deployed on both sides of the vehicle, the CMS cannot display the field of view directly behind or in front of the vehicle. Therefore, when obstacles appear directly behind or in front of the vehicle, the CMS cannot issue timely warnings.

For the above problems, a vehicle trajectory warning method is provided in the embodiments of the present disclosure, where the obstacle information within the preset range of the vehicle and the driving trajectory information of the vehicle are acquired first. Herein, the obstacle information includes a position, a moving speed and a moving direction of each obstacle, and the driving trajectory information is used to indicate a driving trajectory area of the vehicle. Then, a period of collision time of the each obstacle to the driving trajectory area can be determined according to the position, the moving speed and the moving direction of the each obstacle and the driving trajectory information, and an obstacle corresponding to a shortest period of collision time in multiple periods of collision time shorter than a first preset threshold can be determined as a target obstacle. Herein, the first preset threshold is determined according to a collision risk degree of an obstacle. Subsequently, warning information indicating the target obstacle can be displayed in a driving trajectory displayed by the vehicle.

As can be seen from the above, in the present disclosure, after the target obstacle is determined, the warning information indicating the target obstacle can be displayed in the driving trajectory displayed by the vehicle. In this way, by adding the warning information of the target obstacle to the driving trajectory displayed by the vehicle, to remind that there is an obstacle in the driving trajectory of the vehicle. The displaying process of the warning information is clear and concise, and there is no need to display the obstacle in a frame, which solves the technical problems of the complex displaying interface in the existing vehicle warning methods and corresponding poor user experience. Next, displaying the warning information in the driving trajectory can also remind a user that there is a target obstacle on the driving trajectory, thereby avoiding traffic accidents on vehicles.

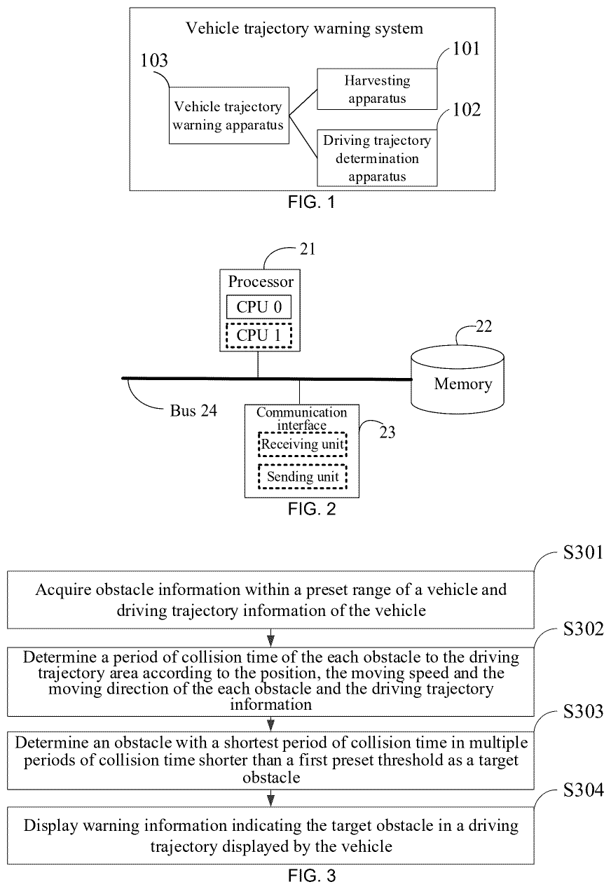

The vehicle trajectory warning method is applicable to a vehicle trajectory warning system. FIG. 1 shows a structure of the vehicle trajectory warning system. As shown in FIG. 1, the vehicle trajectory warning system includes: a harvesting apparatus 101, a driving trajectory determination apparatus 102, and a vehicle trajectory warning apparatus 103.

The vehicle trajectory warning apparatus 103 is connected to the harvesting apparatus 101 and the driving trajectory determination apparatus 102 respectively.

The harvesting apparatus 101 in FIG. 1 is configured to acquire obstacle information in a vehicle driving scenario.

In some embodiments, the harvesting apparatus 101 includes a sonar module and a camera module.

The sonar module is configured to detect the obstacle information such as a distance between an obstacle and a vehicle in the vehicle driving scenario.

The camera module is configured to capture images of a parking position and surrounding obstacles frame by frame during a parking process of the vehicle, to obtain the obstacle information such as a position, a moving direction, a type and a size of an obstacle.

Exemplarily, the harvesting apparatus 101 may be a sensor apparatus such as a camera, a radar, or a CMS.

The driving trajectory determination apparatus 102 in FIG. 1 is configured to obtain steering angle information of a steering wheel of the vehicle, and determine driving trajectory information of the vehicle according to the steering angle information of the steering wheel. For example, when the vehicle is driven forward, the driving trajectory determination apparatus 102 may determine driving trajectory information of front wheels of the vehicle. Correspondingly, when the vehicle is driven backward, the driving trajectory determination apparatus 102 may determine driving trajectory information of rear wheels of the vehicle.

The vehicle trajectory warning apparatus 103 in FIG. 1 is configured to determine a target obstacle according to the obstacle information acquired by the harvesting apparatus 101 and the driving trajectory information of the vehicle determined by the driving trajectory determination apparatus 102, and display warning information indicating the target obstacle in a driving trajectory displayed by the vehicle.

In some embodiments, the vehicle trajectory warning apparatus 103 may be an electronic device such as a center console or an onboard computer installed inside the vehicle, or may be installed at other positions in the vehicle, to implement the vehicle trajectory warning method provided in the embodiments of the present disclosure.

In some embodiments, FIG. 2 shows a structure of hardware of a vehicle trajectory warning apparatus provided in the embodiments of the present disclosure.

As shown in FIG. 2, FIG. 2 is a structural schematic diagram of a hardware of a vehicle trajectory warning apparatus provided in the embodiments of the present disclosure. The vehicle trajectory warning apparatus includes a processor 21, a memory 22, a communication interface 23, and a bus 24. The processor 21, the memory 22 and the communication interface 23 may be connected with each other through the bus 24.

The processor 21 is a control center of the vehicle trajectory warning apparatus, which can be one processor, or may be a collective term for multiple processing elements. For example, the processor 21 may be a general-purpose central processing unit (central processing unit, CPU), or may be another general-purpose processor. The general-purpose processor may be a microprocessor or any conventional processor, etc.

As an embodiment, the processor 21 may include one or more CPUs, such as a CPU 0 and a CPU 1 in FIG. 2.

The memory 22 may be a read-only memory (read-only memory, ROM) or other types of static storage devices that may store static information and instructions, a random access memory (random access memory, RAM), or other types of dynamic storage devices that may store information and instructions, or an electrically erasable programmable read-only memory (electrically erasable programmable read-only memory, EEPROM), a magnetic disk storage medium or any other magnetic storage devices, or any other media that may be used to carry or store desired program codes in the form of instructions or data structure and may be accessed by a computer, which is not limited thereto.

In a possible implementation, the memory 22 may exist independently from the processor 21, and the memory 22 may be connected to the processor 21 through the bus 24 for storing instructions or program codes. When the processor 21 invokes and executes the instructions or program codes stored in the memory 22, the processor 21 may implement the vehicle trajectory warning method provided in the following embodiments of the present disclosure.

In another possible implementation, the memory 22 may be integrated with the processor 21.

The communication interface 23 is configured for connecting the vehicle trajectory warning apparatus with other devices through a communication network. For example, the communication network may be Ethernet, a radio access network, or a wireless local area network (wireless local area network, WLAN), etc. The communication interface 23 may include a receiving unit for receiving data and a sending unit for sending data.

The bus 24 may be an industry standard architecture (industry standard architecture, ISA) bus, a peripheral component interconnect (peripheral component interconnect, PCI) bus, or an extended industry standard architecture (extended industry standard architecture, EISA) bus, etc. The bus may be classified as an address bus, a data bus, a control bus, etc. For ease of representation, only one bold line is used in FIG. 2 for representing the bus 24, but it does not mean that there is only one bus or one type of bus.

It should be pointed out that the structure shown in FIG. 2 does not constitute a limitation on the vehicle trajectory warning apparatus. In addition to the components shown in FIG. 2, the vehicle trajectory warning apparatus may include more or fewer components than the components shown in the drawings, or combine certain components, or have different component arrangements.

A vehicle is further provided in the embodiments of the present disclosure. The vehicle is equipped with the vehicle trajectory warning apparatus shown in FIG. 2.

The vehicle trajectory warning method provided in the embodiments of the present disclosure is described below in detail with reference to the accompanying drawings.

As shown in FIG. 3, the vehicle trajectory warning method provided in the embodiments of the present disclosure is applied to the vehicle trajectory warning apparatus in FIG. 1 or FIG. 2, and the method includes S301-S304.

In S301, the vehicle trajectory warning apparatus acquires obstacle information within a preset range of a vehicle and driving trajectory information of the vehicle.

Specifically, a harvesting apparatus (such as the harvesting apparatus 101 in FIG. 1) can be deployed on the vehicle, where the harvesting apparatus may harvest the obstacle information within the preset range of the vehicle in real time, such as a moving speed, a position, a moving direction, a type and a size of the obstacle, etc. After harvesting the obstacle information within the preset range of the vehicle, the harvesting apparatus can send the obstacle information harvested by the harvesting apparatus to the vehicle trajectory warning apparatus. Accordingly, the vehicle trajectory warning apparatus may acquire the obstacle information within the preset range of the vehicle, so as to subsequently display warning information related to the obstacle.

Secondly, a driving trajectory determination apparatus (such as the driving trajectory determination apparatus 102 in FIG. 1) can be deployed on the vehicle, where the driving trajectory determination apparatus may harvest steering angle information of a steering wheel in real time and determine driving trajectory information of the vehicle based on the steering angle information of the steering wheel. After the driving trajectory information of the vehicle is determined, the driving trajectory determination apparatus may send the determined driving trajectory information to the vehicle trajectory warning apparatus. Correspondingly, the vehicle trajectory warning apparatus may acquire the driving trajectory information of the vehicle, so as to subsequently display a driving trajectory corresponding to the driving trajectory information, and display the warning information related to the obstacle in the driving trajectory displayed by the vehicle.

In S302, the vehicle trajectory warning apparatus determines a period of collision time of each obstacle to a driving trajectory area according to a position, a moving speed and a moving direction of the each obstacle and the driving trajectory information.

Specifically, after the position, the moving speed and the moving direction of the each obstacle, and the driving trajectory information of the vehicle are acquired, the vehicle trajectory warning apparatus may determine the period of collision time of the each obstacle to the driving trajectory area according to the position, the moving speed and the moving direction of the each obstacle, and the driving trajectory information of the vehicle.

Exemplarily, it is assumed that the obstacle information within the preset range of the vehicle acquired by the vehicle trajectory warning apparatus includes: first obstacle information and second obstacle information.

Herein, the first obstacle information includes: a position of a first obstacle being a meter(s) away from the left rear of the vehicle; a moving speed of the first obstacle being: b meter(s) per second; and a moving direction of the first obstacle being a direction of due east.

The second obstacle information includes: a position of a second obstacle being c meter(s) away from the left rear of the vehicle; a moving speed of the second obstacle being: d meter(s) per second; and a moving direction of the second obstacle being a direction of due east, where c>a, d<b.

The driving trajectory information of the vehicle acquired by the vehicle trajectory warning apparatus is a vehicle trajectory of the vehicle reversing toward a direction of due south.

In this case, the vehicle trajectory warning apparatus may determine a period of collision time of the first obstacle to the driving trajectory area as m second(s) according to the first obstacle information and the driving trajectory information of the vehicle.

Correspondingly, the vehicle trajectory warning apparatus may determine that a period of collision time of the second obstacle to the driving trajectory area is n second(s) according to the second obstacle information and the driving trajectory information of the vehicle.

Since c>a, d<b, the period of collision time (m seconds) of the first obstacle to the driving trajectory area determined by the vehicle trajectory warning apparatus<the period of collision time (n seconds) of the second obstacle to the driving trajectory area determined by the vehicle trajectory warning apparatus.

In S303, the vehicle trajectory warning apparatus determines an obstacle corresponding to a shortest period of collision time in multiple periods of collision time shorter than a first preset threshold as a target obstacle.

It should be understood that when there are multiple obstacles within the preset range of the vehicle, if warning information of the respective obstacles is displayed, a displaying interface may be complex, thereby resulting in the poor user experience. In actual applications, when the vehicle may avoid a collision with an obstacle that is closest to the vehicle, the vehicle will not collide with other obstacles that are farther away from the vehicle. Therefore, after the period of collision time of the each obstacle to the driving trajectory area is determined, the vehicle trajectory warning apparatus may determine the obstacle corresponding to the shortest period of collision time in multiple periods of collision time shorter than the first preset threshold as the target obstacle, so as to facilitate the subsequent displaying of warning information indicating the target obstacle in the driving trajectory displayed by the vehicle.

Herein, the first preset threshold is determined according to a collision risk degree of an obstacle. For example, when a period of collision time of the obstacle to the vehicle is shorter than 5 seconds, it can be determined that a collision risk degree of the obstacle is relatively high. In this case, the first preset threshold may be set to 5 seconds.

Of course, in practical applications, the first preset threshold may also be reasonably adjusted according to manual experience, which is not limited in the embodiments of the present disclosure.

In actual applications, when there are multiple obstacles within a range close to the vehicle, the first preset threshold set according to the manual experience may screen out several obstacles in the multiple obstacles. In this case, the vehicle trajectory warning apparatus determines the obstacle corresponding to the shortest period of collision time in multiple periods of collision time shorter than the first preset threshold as the target obstacle.

It should be noted that when the obstacle is very close to the vehicle but is moving away from the vehicle, the vehicle trajectory warning apparatus may determine that the period of collision time corresponding to the obstacle is infinite, that is, the obstacle cannot be considered as a target obstacle.

In S304, the vehicle trajectory warning apparatus displays warning information indicating the target obstacle in a driving trajectory displayed by the vehicle.

Specifically, after the target obstacle is determined, in order to improve the simplicity of the displaying interface for the warning information, the vehicle trajectory warning apparatus may display the warning information indicating the target obstacle in the driving trajectory displayed by the vehicle.

In some embodiments, the warning information of the target obstacle may include: a direction mark for indicating an obstacle direction of the target obstacle, a type of the target obstacle, a first warning color for indicating a first collision risk degree, a second warning color for indicating a second collision risk degree, and a third warning color for indicating a third collision risk degree, or other warning information.

Herein, risk degrees of the first collision risk degree, the second collision risk degree, and the third collision risk degree decrease in sequence, and color reminder levels of the first warning color, the second warning color, and the third warning color decrease in sequence.

In this way, by adding detailed warning information of the target obstacle in the driving trajectory displayed by the vehicle, to remind that there is an obstacle in the driving trajectory of the vehicle. A displaying process of the warning information is clear and concise, and there is no need to display the obstacle in a frame, which solves the technical problems of the complex displaying interface of the existing vehicle warning method and corresponding poor user experience. Next, displaying the warning information in the driving trajectory can also remind a user that there is a target obstacle on the driving trajectory, thereby avoiding traffic accidents on vehicles.

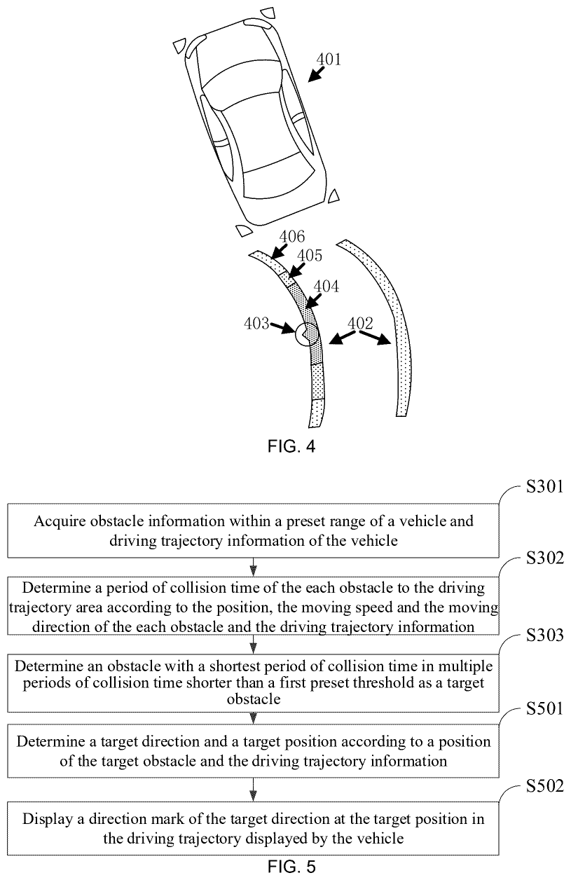

Exemplarily, FIG. 4 shows a schematic diagram of a displaying interface of warning information provided in the embodiments of the present disclosure. As shown in FIG. 4, the displaying interface may include a contour 401 of a vehicle and a driving trajectory 402 of the vehicle. In order to improve the simplicity of the displaying interface of the warning information, the driving trajectory 402 of the vehicle may include: a direction mark 403 for indicating an obstacle direction of a target obstacle, a first warning color 404 for indicating a first collision risk degree, a second warning color 405 for indicating a second collision risk degree, and a third warning color 406 for indicating a third collision risk degree.

Herein, different types of obstacles can be displayed according to different direction marks.

The vehicle trajectory warning method provided in the embodiments of the present disclosure is described below in detail with reference to different warning contents in the warning information.

In a case where the warning information includes a direction mark for indicating an obstacle direction, the vehicle trajectory warning apparatus needs to determine a direction of the target obstacle with respect to the driving trajectory and a position in the driving trajectory and that is closest to the position of the target obstacle in advance. In this case, in combination with FIG. 3, as shown in FIG. 5, before the vehicle trajectory warning apparatus displays the warning information indicating the target obstacle in the driving trajectory displayed by the vehicle, the method further includes S501.

In S501, the vehicle trajectory warning apparatus determines a target direction and a target position according to a position of the target obstacle and the driving trajectory information.

Herein, the target direction is a direction of the target obstacle with respect to the driving trajectory, and the target position is a position in the driving trajectory and that is closest to the position of the target obstacle.

Specifically, in order to accurately display a direction mark for indicating an obstacle direction, the vehicle trajectory warning apparatus may determine the target direction and target position according to the position of the target obstacle and the driving trajectory information.

After the target direction and the target position are determined, in the above S304, the method where the vehicle trajectory warning apparatus displays the warning information indicating the target obstacle in the driving trajectory displayed by the vehicle specifically includes S502.

In S502, the vehicle trajectory warning apparatus displays a direction mark of the target direction at the target position in the driving trajectory displayed by the vehicle.

Specifically, after the target direction and the target position are determined, the vehicle trajectory warning apparatus may display the direction mark of the target direction (such as the direction mark 403 in FIG. 4) at the target position in the driving trajectory displayed by the vehicle. A displaying direction of the direction mark is the target direction determined in S501. Correspondingly, a displaying position of the direction mark is the target position determined in S501.

As set forth above, it can be seen that when the warning information is displayed, the vehicle trajectory warning apparatus may determine the target direction and target position according to obstacle information of the target obstacle, and then display the direction mark of the target direction at the target position in the driving trajectory displayed by the vehicle, so as to remind a user of the direction and the position of the target obstacle, thus enriching the warning contents of the warning information, and further, improving the user experience.

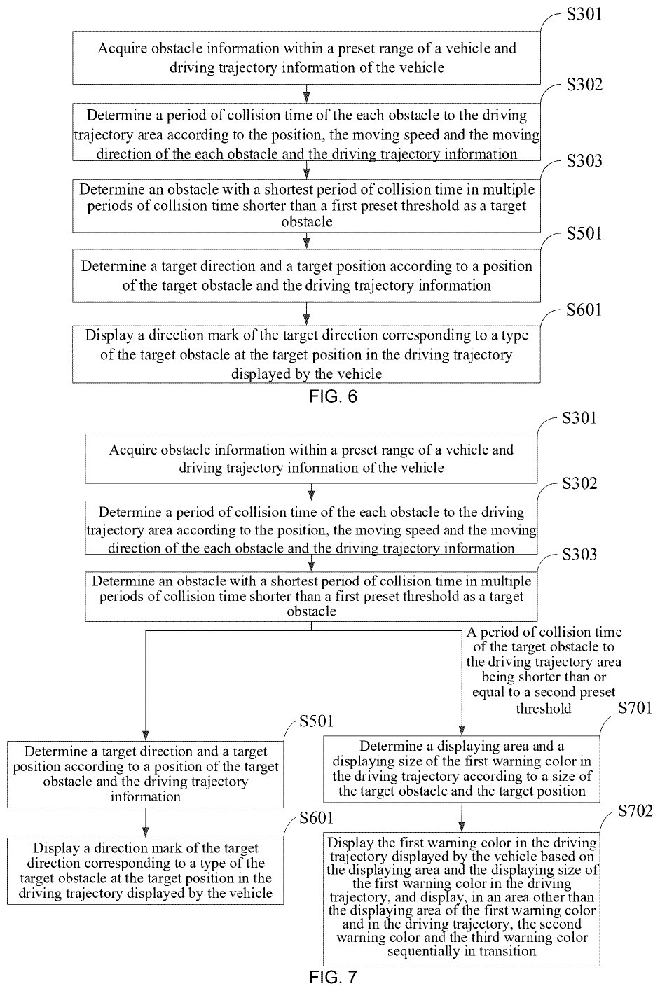

In order to enrich the warning contents of the warning information, the vehicle trajectory warning apparatus may further display different direction marks according to different types of obstacles. In this case, the obstacle information further includes a type of each obstacle, and direction marks of different types of obstacles are different. In combination with FIG. 5, as shown in FIG. 6, in a case where the obstacle information further includes a type of the each obstacle, in the above S502, the method where the vehicle trajectory warning apparatus displays the direction mark of the target direction at the target position in the driving trajectory displayed by the vehicle specifically includes S601.

In S601, the vehicle trajectory warning apparatus displays a direction mark of the target direction corresponding to a type of the target obstacle at the target position in the driving trajectory displayed by the vehicle.

Exemplarily, when an obstacle type of the target obstacle is a person, the direction mark 403 may be a single arrow. When the obstacle type of the target obstacle is a building, the direction mark 403 may be a double arrow.

In order to enrich the warning contents of the warning information, the vehicle trajectory warning apparatus may further display a collision risk degree corresponding to the target obstacle according to a warning color. In this case, the obstacle information further includes a size of the each obstacle; the warning information further includes: a first warning color for indicating a first collision risk degree, a second warning color for indicating a second collision risk degree, and a third warning color for indicating a third collision risk degree.

It should be understood that when the target obstacle corresponds to different collision risk degrees, the vehicle trajectory warning apparatus may display different warning colors.

Exemplarily, it is assumed that a second preset threshold is 3 seconds, the first preset threshold is 5 seconds, the first warning color is red, the second warning color is yellow, and the third warning color is green.

When the period of collision time of the target obstacle to the driving trajectory area is shorter than or equal to 3 seconds, the vehicle trajectory warning apparatus may display, in the driving trajectory, a warning color of red in an area corresponding to the target obstacle. At the same time, in order to enrich displaying contents of the warning information, the vehicle trajectory warning apparatus may further display, in an area other than the area in red and in the driving trajectory, colors of yellow and green sequentially in transition.

When the period of collision time of the target obstacle to the driving trajectory area is longer than 3 seconds and shorter than 5 seconds, the vehicle trajectory warning apparatus may display, in the driving trajectory, a warning color of yellow in the area corresponding to the target obstacle. At the same time, in order to enrich the displaying contents of the warning information, the vehicle trajectory warning apparatus may further display, in an area other than the area in yellow and in the driving trajectory, a color of green in transition.

When the period of collision time of the target obstacle to the driving trajectory area is longer than or equal to 5 seconds, the vehicle trajectory warning apparatus may display all-green driving trajectory.

In a possible implementation, when the period of collision time of the target obstacle to the driving trajectory area is shorter than or equal to the second preset threshold, since the second preset threshold is a threshold shorter than the first preset threshold, the target obstacle is in a position with a relatively high risk degree. In this case, since a color reminder level corresponding to the first warning color is also a relatively high reminder level, the vehicle trajectory warning apparatus may display the first warning color. At the same time, in order to enrich the displaying contents of the warning information, the vehicle trajectory warning apparatus may further display, in an area other than the area in the first warning color and in the driving trajectory, the second warning color and the third warning color in transition.

Herein, the second preset threshold may also be determined according to a collision risk degree of an obstacle. However, the collision risk degree of the obstacle corresponding to the second preset threshold is higher than a collision risk degree of an obstacle corresponding to the first preset threshold. For example, when a period of collision time of an obstacle to the vehicle is shorter than 3 seconds, it can be determined that a collision risk degree of the obstacle is higher. In this case, the second preset threshold may be set as 3 seconds.

Of course, in practical applications, the second preset threshold may also be reasonably adjusted according to manual experience, which is not limited in the embodiments of the present disclosure.

Specifically, in combination with FIG. 6, as shown in FIG. 7, when the period of collision time of the target obstacle to the driving trajectory area is shorter than or equal to the second preset threshold, before the vehicle trajectory warning apparatus displays the warning information indicating the target obstacle in the driving trajectory displayed by the vehicle, the method further includes S701.

In S701, the vehicle track warning apparatus determines a displaying area and a displaying size of the first warning color in the driving trajectory according to a size of the target obstacle and the target position.

Herein, the displaying area is an area spreading from the target position to both sides of the driving trajectory, and the displaying size is a physical size of the target obstacle mapped on the driving trajectory.

Specifically, since the target obstacle is usually an object with a certain size, a possible collision area of the target obstacle in the driving trajectory is also an area with a certain size. A size of the collision area is usually the same or similar to a size of the obstacle. In this case, the vehicle trajectory warning apparatus may determine the displaying size of the first warning color in the driving trajectory (that is, a physical size of the target obstacle mapped on the driving trajectory) according to the size of the target obstacle.

Next, after the displaying size of the first warning color in the driving trajectory is determined, the vehicle trajectory warning apparatus may determine the displaying area of the first warning color in the driving trajectory according to the displaying size of the first warning color in the driving trajectory and the first warning color being spread from the target position to both sides of the driving trajectory.

After the displaying area and the displaying size of the first warning color in the driving trajectory is determined, in the above S304, the method where the vehicle trajectory warning apparatus displays the warning information indicating the target obstacle in the driving trajectory displayed by the vehicle specifically includes S702.

In S702, the vehicle trajectory warning apparatus displays the first warning color in the driving trajectory displayed by the vehicle based on the displaying area and the displaying size of the first warning color in the driving trajectory, and displays, in an area other than the displaying area of the first warning color and in the driving trajectory, the second warning color and the third warning color sequentially in transition.

In some embodiments, a displaying size of the second warning color may be a fixed size, or may be determined according to a ratio of the displaying size of the first warning color, which is not limited in the embodiments of the present disclosure.

Exemplarily, as shown in FIG. 4, the first warning color may be a first warning color 404 for indicating the first collision risk degree. The second warning color may be a second warning color 405 for indicating the second collision risk degree. The third warning color may be a third warning color 406 for indicating the third collision risk degree.

In some embodiments, since a risk degree of the first collision risk degree is relatively high, the first warning color is usually red. Of course, the first warning color may also be set as another color, which is not limited in the embodiments of the present disclosure.

Correspondingly, since a risk degree of the second collision risk degree is moderate, the second warning color is usually yellow. Of course, the second warning color may also be set as another color corresponding to a reminder level lower than that of the first warning color, which is not limited in the embodiments of the present disclosure.

Correspondingly, since a risk degree of the third collision risk degree is relatively low, the third warning color is usually green. Of course, the third warning color may also be set as another color corresponding to a reminder level lower than that of the second warning color, which is not limited in the embodiments of the present disclosure.

In yet another possible implementation, when the period of collision time of the target obstacle to the driving trajectory area is longer than a second preset threshold and shorter than a first preset threshold, the target obstacle is located at a position with a moderate risk degree. In this case, since a color reminder level corresponding to the second warning color is also a moderate reminder level, the vehicle trajectory warning apparatus may display the second warning color without displaying the first warning color with a relatively high color reminder level. At the same time, in order to enrich the displaying contents of the warning information, the vehicle trajectory warning apparatus may further display, in an area other than the displaying area of the second warning color and in the driving trajectory, the third warning color in transition.

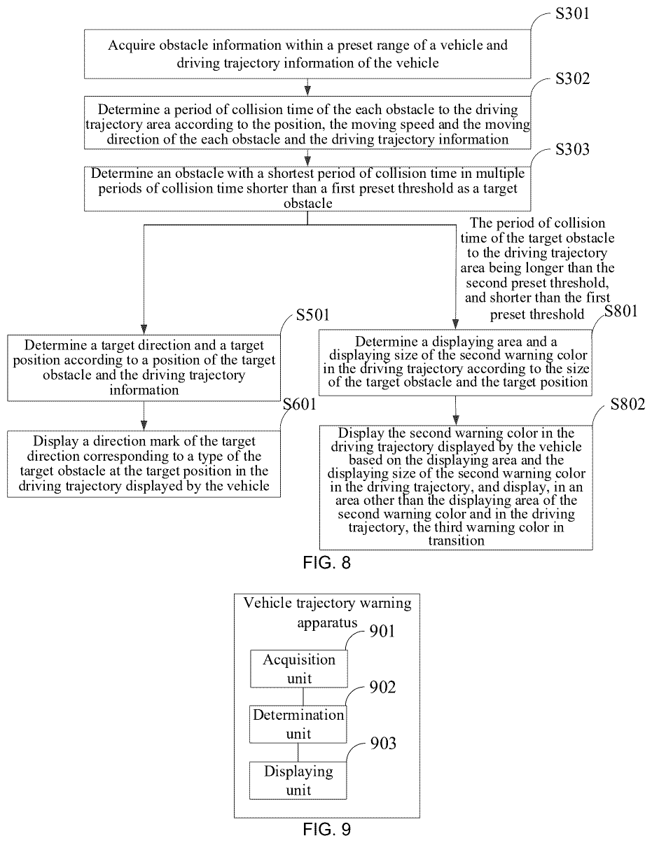

Specifically, in combination with FIG. 6, as shown in FIG. 8, when the period of collision time of the target obstacle to the driving trajectory area is longer than the second preset threshold and shorter than the first preset threshold, before the vehicle track warning apparatus displays the warning information indicating the target obstacle in the driving track displayed by the vehicle, the method further includes S801.

In S801, the vehicle trajectory warning apparatus determines a displaying area and a displaying size of the second warning color in the driving trajectory according to the size of the target obstacle and the target position.

A specific implementation of the vehicle trajectory warning apparatus determining the displaying area and the displaying size of the second warning color in the driving trajectory according to the size of the target obstacle and the target position may refer to the relevant description of operation S701, which will not be repeated herein.

After the displaying area and the displaying size of the second warning color in the driving trajectory are determined, in the above S304, the method where the vehicle trajectory warning apparatus displays the warning information indicating the target obstacle in the driving trajectory displayed by the vehicle specifically includes S802.

In S802, the vehicle trajectory warning apparatus displays the second warning color in the driving trajectory displayed by the vehicle based on the displaying area and the displaying size of the second warning color in the driving trajectory, and displays, in an area other than the displaying area of the second warning color and in the driving trajectory, the third warning color in transition.

In some embodiments, since a color reminder level corresponding to the second warning color is a moderate reminder level, the second warning color may be yellow. Correspondingly, since a color reminder level corresponding to the third warning color is a reminder level lower than that of the second warning color, the third warning color may be green.

In yet another possible implementation, when the period of collision time of the target obstacle to the driving trajectory area is longer than or equal to the first preset threshold, since the first preset threshold is a threshold longer than the second preset threshold, the target obstacle is in a position with a relatively low risk degree. In this case, since the color reminder level corresponding to the third warning color is also a relatively low reminder level, the vehicle trajectory warning apparatus may display all of the driving trajectory in the third warning color.

In summary, in the present disclosure, after the target obstacle is determined, abundant warning information indicating the target obstacle may be displayed in the driving trajectory displayed by the vehicle, the abundant warning information includes: a direction mark for indicating an obstacle direction and an obstacle type of the target obstacle, a first warning color for indicating a first collision risk degree, a second warning color for indicating a second collision risk degree, and a third warning color for indicating a third collision risk degree, etc. In this way, by adding abundant warning information of the target obstacle in the driving trajectory displayed by the vehicle, to remind that there is an obstacle in the driving trajectory of the vehicle. A displaying process of the warning information is clear and concise, and there is no need to display the obstacle in a frame, which solves the technical problems of the complex displaying interface of the existing vehicle warning method and corresponding poor user experience. Next, displaying the warning information in the driving trajectory can also remind a user that there is a target obstacle on the driving trajectory, thereby avoiding traffic accidents on vehicles.

The solutions provided in the embodiments of the present disclosure are introduced above from the perspective of methods. In order to implement the above functions, hardware structures and/or software modules for performing corresponding functions are included. Those skilled in the art should easily realize that the present disclosure can be implemented in the form of hardware or a combination of hardware and computer software in combination with units and algorithm steps of examples described in the embodiments disclosed by the description. Whether a certain function is implemented by hardware or by computer software driving hardware depends on the specific application and design constraint conditions of the technical solutions. Professional technicians may use different methods to implement the described functions for each specific application, but such implementation should not be considered beyond the scope of the present disclosure.

The embodiments of the present disclosure may divide a supporting server into functional modules according to the above method examples. For example, the division of various functional modules may be performed corresponding to various functions, or two or more functions may be integrated into one processing module. The integrated module may be implemented in the form of hardware, or may be implemented in the form of software functional module. In some embodiments, the division of the modules in the embodiments of the present disclosure is illustrated, which is only a logical functional division, and there may be other division manners in an actual implementation.

As shown in FIG. 9, FIG. 9 is a structural schematic diagram of a vehicle trajectory warning apparatus provided in the embodiments of the present disclosure. The vehicle trajectory warning apparatus may be configured to perform the vehicle trajectory warning method shown in FIG. 3 and FIGS. 5 to 8. The vehicle trajectory warning apparatus shown in FIG. 9 includes: an acquisition unit 901, a determination unit 902, and a displaying unit 903;
the acquisition unit 901 is configured to acquire obstacle information within a preset range of a vehicle and driving trajectory information of the vehicle, where the obstacle information includes a position, a moving speed and a moving direction of each obstacle, and the driving trajectory information is used to indicate a driving trajectory area of the vehicle;
the determination unit 902 is configured to determine a period of collision time of the each obstacle to the driving trajectory area according to the position, the moving speed and the moving direction of the each obstacle and the driving trajectory information;
the determination unit 902 is further configured to determine an obstacle corresponding to a shortest period of collision time in multiple periods of collision time shorter than a first preset threshold as a target obstacle, where the first preset threshold is determined according to a collision risk degree of an obstacle; and
the displaying unit 903 is configured to display warning information indicating the target obstacle in a driving trajectory displayed by the vehicle.

In some embodiments, the warning information includes: a direction mark for indicating an obstacle direction;
the determination unit 902 is further configured to determine a target direction and a target position according to a position of the target obstacle and the driving trajectory information, where the target direction is a direction of the target obstacle with respect to the driving trajectory, the target position is a position in the driving trajectory and that is closest to the position of the target obstacle;
the displaying unit 903 is specifically configured to display a direction mark of the target direction at the target position in the driving trajectory displayed by the vehicle.

In some embodiments, the obstacle information further includes a type of each obstacle, and direction marks of different types of obstacles are different; the displaying unit 903 is specifically configured to:
display a direction mark of the target direction corresponding to a type of the target obstacle at the target position in the driving trajectory displayed by the vehicle.

In some embodiments, the obstacle information further includes a size of the each obstacle, the warning information further includes: a first warning color for indicating a first collision risk degree, a second warning color for indicating a second collision risk degree, and a third warning color for indicating a third collision risk degree, risk degrees of the first collision risk degree, the second collision risk degree, and the third collision risk degree decrease in sequence, and color reminder levels of the first warning color, the second warning color, and the third warning color decrease in sequence;
in a case where a period of collision time of the target obstacle to the driving trajectory area is shorter than or equal to a second preset threshold, the determination unit 902 is further configured to determine a displaying area and a displaying size of the first warning color in the driving trajectory according to a size of the target obstacle and the target position, the displaying area is an area spreading from the target position to both sides of the driving trajectory, the displaying size is a physical size of the target obstacle mapped on the driving trajectory, and the second preset threshold is shorter than the first preset threshold;
the displaying unit 903 is specifically configured to display the first warning color in the driving trajectory displayed by the vehicle based on the displaying area and the displaying size of the first warning color in the driving trajectory, and display, in an area other than the displaying area of the first warning color and in the driving trajectory, the second warning color and the third warning color sequentially in transition.

In some embodiments, in a case where the period of collision time of the target obstacle to the driving trajectory area is longer than the second preset threshold and shorter than the first preset threshold, the determination unit 902 is further configured to determine a displaying area and a displaying size of the second warning color in the driving trajectory according to the size of the target obstacle and the target position;
the displaying unit 903 is specifically configured to:
display the second warning color in the driving trajectory displayed by the vehicle based on the displaying area and the displaying size of the second warning color in the driving trajectory, and display, in an area other than the displaying area of the second warning color and in the driving trajectory, the third warning color in transition.

A computer-readable storage medium is further provided in the embodiments of the present disclosure. The computer-readable storage medium includes computer execution instructions that, upon being run on a computer, enable the computer to perform the vehicle trajectory warning method provided in the above-mentioned embodiments.

A computer program is further provided in the embodiments of the present disclosure. The computer program may be directly loaded into a memory and includes software codes. After being loaded and executed by a computer, the computer program can implement the vehicle trajectory warning method provided in the above-mentioned embodiments.

Those skilled in the art should be aware that, in one or more of the above examples, the functions described in the present disclosure can be implemented by hardware, software, firmware, or any combination thereof. When implemented by using software, the functions may be stored in a computer-readable storage medium or may be transmitted as one or more instructions or codes on the computer-readable medium. The computer-readable medium includes a computer-readable storage medium and a communication medium, where the communication medium includes any medium that facilitates the transfer of a computer program from one place to another place. The storage medium may be any available medium that can be accessed by a general-purpose computer or a special-purpose computer.

Through the description of the above implementations, those of ordinary skill in the art can clearly understand that for the convenience and simplicity of the description, the division of the above functional modules is given merely as an example. In practical applications, the above functions can be allocated to be accomplished by different functional modules according to requirements, that is, the internal structure of the apparatus can be divided into different functional modules to complete all or part of the functions described above.

In the several embodiments provided in the present disclosure, it should be understood that the disclosed apparatuses and methods can be implemented in other ways. For example, the apparatus embodiments described above are only illustrative. For example, the division of modules or units is only a logical functional division. In actual implementation, there may be other division manners. For example, multiple units or components can be combined or integrated into another apparatus, or some features can be ignored or not performed. On the other hand, the coupling or direct coupling or communicative connection between each other as shown or discussed above may be an indirect coupling or a communicative connection via some interfaces, apparatuses or units, which may be electrical, mechanical, or in other forms. The units described as separate components may or may not be physically separated, and a component shown as a unit may be one physical unit or multiple physical units, that is, the component shown as a unit may be located in one place, or may be distributed to multiple different places. A part or all of the units may be selected according to actual needs, to implement the purpose of the solutions of the embodiments.

In addition, various functional units in various embodiments of the present disclosure may be integrated into a single processing unit or various units may exist physically and separately, or two or more units may be integrated into one unit. The above integrated unit may be implemented in the form of hardware, or may be implemented in the form of a software functional unit. If the integrated unit is implemented in the form of the software functional unit and sold or used as an independent product, the integrated unit may be stored in a readable storage medium. Based on this understanding, the technical solutions of embodiments of the present disclosure may be essentially, or a part of the technical solutions of embodiments of the present disclosure that contributes to the existing technology may be, or a part or all of the technical solutions may be, embodied in the form of a software product, the software product is stored in a storage medium, and the software product includes several instructions to enable a device (which may be a single-chip microcomputer, a chip, etc.) or a processor to perform all or a part of steps of methods in various embodiments of the present disclosure. The aforementioned storage medium include: a U disk, a mobile hard disk, a ROM, a RAM, a magnetic disk or an optical disk and other media that can store program codes.

The above description is only a specific implementation of the present disclosure, but the protection scope of the present disclosure is not limited thereto, and changes or substitutions that may be easily thought of within the technical scope disclosed in the embodiments of the present disclosure by any skilled in the art familiar with this technical field should be all covered within the protection scope of the present disclosure. Therefore, the protection scope of the present disclosure shall be subject to the protection scope of the claims.

What is claimed is:

1. A vehicle trajectory warning method, comprising:
acquiring obstacle information within a preset range of a vehicle and driving trajectory information of the vehicle, wherein the obstacle information includes a position, a moving speed and a moving direction of each obstacle, and the driving trajectory information is used to indicate a driving trajectory area of the vehicle;
determining a period of collision time of the each obstacle to the driving trajectory area according to the position, the moving speed and the moving direction of the each obstacle and the driving trajectory information;
determining an obstacle corresponding to a shortest period of collision time in multiple periods of collision time shorter than a first preset threshold as a target obstacle, wherein the first preset threshold is determined according to a collision risk degree of an obstacle; and
displaying warning information indicating the target obstacle in a driving trajectory displayed by the vehicle.

2. The vehicle trajectory warning method according to claim 1, wherein the warning information includes: a direction mark for indicating an obstacle direction; before displaying the warning information indicating the target obstacle in the driving trajectory displayed by the vehicle, the method further comprises:
determining a target direction and a target position according to a position of the target obstacle and the driving trajectory information, wherein the target direction is a direction of the target obstacle with respect to the driving trajectory, the target position is a position in the driving trajectory and that is closest to the position of the target obstacle;
the displaying the warning information indicating the target obstacle in the driving trajectory displayed by the vehicle comprises:
displaying a direction mark of the target direction at the target position in the driving trajectory displayed by the vehicle.

3. The vehicle trajectory warning method according to claim 2, wherein the obstacle information further includes a type of the each obstacle, direction marks of different types of obstacles are different, and the displaying the direction mark of the target direction at the target position in the driving trajectory displayed by the vehicle comprises:
displaying a direction mark of the target direction corresponding to a type of the target obstacle at the target position in the driving trajectory displayed by the vehicle.

4. The vehicle trajectory warning method according to claim 2, wherein the obstacle information further includes a size of the each obstacle, the warning information further includes: a first warning color for indicating a first collision risk degree, a second warning color for indicating a second collision risk degree, and a third warning color for indicating a third collision risk degree; risk degrees of the first collision risk degree, the second collision risk degree, and the third collision risk degree decrease in sequence, and color reminder levels of the first warning color, the second warning color, and the third warning color decrease in sequence;
in a case where a period of collision time of the target obstacle to the driving trajectory area is shorter than or equal to a second preset threshold, before the displaying the warning information indicating the target obstacle in the driving trajectory displayed by the vehicle, the method further comprises:
determining a displaying area and a displaying size of the first warning color in the driving trajectory according to a size of the target obstacle and the target position, wherein the displaying area is an area spreading from the target position to both sides of the driving trajectory, the displaying size is a physical size of the target obstacle mapped on the driving trajectory, and the second preset threshold is shorter than the first preset threshold;
the displaying the warning information indicating the target obstacle in the driving trajectory displayed by the vehicle comprises:
displaying the first warning color in the driving trajectory displayed by the vehicle based on the displaying area and the displaying size of the first warning color in the driving trajectory, and displaying, in an area other than the displaying area of the first warning color and in the driving trajectory, the second warning color and the third warning color sequentially in transition.

5. The vehicle trajectory warning method according to claim 4, wherein in a case where the period of collision time of the target obstacle to the driving trajectory area is longer than the second preset threshold and shorter than the first preset threshold, before the displaying the warning information indicating the target obstacle in the driving trajectory displayed by the vehicle, the method further comprises:
determining a displaying area and a displaying size of the second warning color in the driving trajectory according to the size of the target obstacle and the target position;
the displaying the warning information indicating the target obstacle in the driving trajectory displayed by the vehicle comprises:
displaying the second warning color in the driving trajectory displayed by the vehicle based on the displaying area and the displaying size of the second warning color in the driving trajectory, and displaying, in an area other than the displaying area of the second warning color and in the driving trajectory, the third warning color in transition.

6. A vehicle trajectory warning apparatus, comprising: an acquisition unit, a determination unit and a displaying unit; wherein
the acquisition unit is configured to acquire obstacle information within a preset range of a vehicle and driving trajectory information of the vehicle, wherein the obstacle information includes a position, a moving speed and a moving direction of each obstacle, and the driving trajectory information is used to indicate a driving trajectory area of the vehicle;
the determination unit is configured to determine a period of collision time of the each obstacle to the driving trajectory area according to the position, the moving speed and the moving direction of the each obstacle and the driving trajectory information;
the determination unit is further configured to determine an obstacle corresponding to a shortest period of collision time in multiple periods of collision time shorter than a first preset threshold as a target obstacle, wherein the first preset threshold is determined according to a collision risk degree of an obstacle; and
the displaying unit is configured to display warning information indicating the target obstacle in a driving trajectory displayed by the vehicle.

7. The vehicle trajectory warning apparatus according to claim 6, wherein the warning information includes: a direction mark for indicating an obstacle direction;
the determination unit is further configured to determine a target direction and a target position according to a position of the target obstacle and the driving trajectory information, wherein the target direction is a direction of the target obstacle with respect to the driving trajectory, the target position is a position in the driving trajectory and that is closest to the position of the target obstacle;
the displaying unit is specifically configured to: display a direction mark of the target direction at the target position in the driving trajectory displayed by the vehicle.

8. The vehicle trajectory warning apparatus according to claim 7, wherein the obstacle information further includes a type of the each obstacle, direction marks of different types of obstacles are different, and the displaying unit is specifically configured to:
display a direction mark of the target direction corresponding to a type of the target obstacle at the target position in the driving trajectory displayed by the vehicle.

9. The vehicle trajectory warning apparatus according to claim 7, wherein the obstacle information further includes a size of the each obstacle, the warning information further includes: a first warning color for indicating a first collision risk degree, a second warning color for indicating a second collision risk degree, and a third warning color for indicating a third collision risk degree, risk degrees of the first collision risk degree, the second collision risk degree, and the third collision risk degree decrease in sequence, and color reminder levels of the first warning color, the second warning color, and the third warning color decrease in sequence;
in a case where a period of collision time of the target obstacle to the driving trajectory area is shorter than or equal to a second preset threshold, the determination unit is further configured to determine a displaying area and a displaying size of the first warning color in the driving trajectory according to a size of the target obstacle and the target position, wherein the displaying area is an area spreading from the target position to both sides of the driving trajectory, the displaying size is a physical size of the target obstacle mapped on the driving trajectory, and the second preset threshold is shorter than the first preset threshold;
the displaying unit is specifically configured to: display the first warning color in the driving trajectory displayed by the vehicle based on the displaying area and the displaying size of the first warning color in the driving trajectory, and display, in an area other than the displaying area of the first warning color and in the driving trajectory, the second warning color and the third warning color sequentially in transition.

10. The vehicle trajectory warning apparatus according to claim 8, wherein in a case where the period of collision time of the target obstacle to the driving trajectory area is longer than the second preset threshold and shorter than the first preset threshold, the determination unit is further configured to determine a displaying area and a displaying size of the second warning color in the driving trajectory according to the size of the target obstacle and the target position;
the displaying unit is specifically configured to:
display the second warning color in the driving trajectory displayed by the vehicle based on the displaying area and the displaying size of the second warning color in the driving trajectory, and display, in an area other than the displaying area of the second warning color and in the driving trajectory, the third warning color in transition.

11. A vehicle trajectory warning apparatus, comprising a memory and a processor; wherein the memory is configured to store computer execution instructions, and the processor is connected to the memory through a bus; when the vehicle trajectory warning apparatus is running, the processor executes the computer execution instructions stored in the memory, so as to enable the vehicle trajectory warning apparatus to:
acquire obstacle information within a preset range of a vehicle and driving trajectory information of the vehicle, wherein the obstacle information includes a position, a moving speed and a moving direction of each obstacle, and the driving trajectory information is used to indicate a driving trajectory area of the vehicle;
determine a period of collision time of the each obstacle to the driving trajectory area according to the position, the moving speed and the moving direction of the each obstacle and the driving trajectory information;
determine an obstacle corresponding to a shortest period of collision time in multiple periods of collision time shorter than a first preset threshold as a target obstacle, wherein the first preset threshold is determined according to a collision risk degree of an obstacle; and
display warning information indicating the target obstacle in a driving trajectory displayed by the vehicle.

12. The vehicle trajectory warning apparatus according to claim 11, wherein the warning information includes: a direction mark for indicating an obstacle direction; and before displaying the warning information indicating the target obstacle in the driving trajectory displayed by the vehicle, the vehicle trajectory warning apparatus is further enabled to:
determine a target direction and a target position according to a position of the target obstacle and the driving trajectory information, wherein the target direction is a direction of the target obstacle with respect to the driving trajectory, the target position is a position in the driving trajectory and that is closest to the position of the target obstacle; and
display a direction mark of the target direction at the target position in the driving trajectory displayed by the vehicle.

13. The vehicle trajectory warning apparatus according to claim 12, wherein the obstacle information further includes a type of the each obstacle, direction marks of different types of obstacles are different, and the vehicle trajectory warning apparatus is further enabled to:
display a direction mark of the target direction corresponding to a type of the target obstacle at the target position in the driving trajectory displayed by the vehicle.

14. The vehicle trajectory warning apparatus according to claim 12, wherein the obstacle information further includes a size of the each obstacle, the warning information further includes: a first warning color for indicating a first collision risk degree, a second warning color for indicating a second collision risk degree, and a third warning color for indicating a third collision risk degree; risk degrees of the first collision risk degree, the second collision risk degree, and the third collision risk degree decrease in sequence, and color reminder levels of the first warning color, the second warning color, and the third warning color decrease in sequence;
in a case where a period of collision time of the target obstacle to the driving trajectory area is shorter than or equal to a second preset threshold, before displaying the warning information indicating the target obstacle in the driving trajectory displayed by the vehicle, the vehicle trajectory warning apparatus is further enabled to:
determine a displaying area and a displaying size of the first warning color in the driving trajectory according to a size of the target obstacle and the target position, wherein the displaying area is an area spreading from the target position to both sides of the driving trajectory, the displaying size is a physical size of the target obstacle mapped on the driving trajectory, and the second preset threshold is shorter than the first preset threshold; and
display the first warning color in the driving trajectory displayed by the vehicle based on the displaying area and the displaying size of the first warning color in the driving trajectory, and display, in an area other than the displaying area of the first warning color and in the driving trajectory, the second warning color and the third warning color sequentially in transition.

15. The vehicle trajectory warning apparatus according to claim 14, wherein in a case where the period of collision time of the target obstacle to the driving trajectory area is longer than the second preset threshold and shorter than the first preset threshold, before displaying the warning information indicating the target obstacle in the driving trajectory displayed by the vehicle, the vehicle trajectory warning apparatus is further enabled to:
determine a displaying area and a displaying size of the second warning color in the driving trajectory according to the size of the target obstacle and the target position; and
display the second warning color in the driving trajectory displayed by the vehicle based on the displaying area and the displaying size of the second warning color in the driving trajectory, and displaying, in an area other than the displaying area of the second warning color and in the driving trajectory, the third warning color in transition.

16. A non-transitory computer-readable storage medium, wherein the computer-readable storage medium comprises computer execution instructions that, upon being run on a computer, enable the computer to perform the vehicle trajectory warning method according claim 1.

17. A vehicle, comprising the vehicle trajectory warning apparatus according to claim 11.
